(19) United States
(12) Patent Application Publication
(10) Pub. No.: US 2012/0179573 A1
(43) Pub. Date: Jul. 12, 2012

(54) Methods and Systems for Communicating Social Expression

(75) Inventors: Frank Falcone, Etobicoke (CA); Maksims Volkovs, Toronto (CA)

(73) Assignee: TRIGGERFOX CORPORATION, Etobicoke (CA)

(21) Appl. No.: 13/345,205

(22) Filed: Jan. 6, 2012

Related U.S. Application Data
(60) Provisional application No. 61/430,306, filed on Jan. 6, 2011.

(51) Int. Cl. G06F 15/16; G06Q 30/06

(52) U.S. Cl. 705/26.8; 705/26.1; 709/204

(57) ABSTRACT

In one aspect, a method for communicating social expression to a contact, the method comprising: creating an aggregated social profile, the aggregated social profile comprising a plurality of informational items about the contact collected from a first plurality of data sources; monitoring a second plurality of data sources for at least one trigger event related to at least one informational item of the plurality of informational items; and initiating a social expression action in response to the at least one trigger event. The embodiments may also be directed at generating at least one keyword from the at least one informational item; and scanning for the at least one keyword in the second plurality of data sources. The method may also provide in further aspects, analyzing the at least one trigger event to determine the appropriate social expression action and/or placing an order with a social expression service provider.

### CROSS-REFERENCE TO RELATED APPLICATIONS

Applicants claim the benefit of U.S. Provisional Application No. 61/430,306 entitled “METHODS AND SYSTEMS FOR COMMUNICATING SOCIAL EXPRESSION” filed Jan. 6, 2011, which application is incorporated herein by reference in its entirety.

### FIELD

The described embodiments relate to methods and systems for communicating social expression. More particularly, the embodiments relate to systems and methods for initiating a social expression action in response to at least one trigger event in a plurality of data sources.

### INTRODUCTION

Existing relationship management systems aim to help individuals keep in touch with their network of contacts. Information stored in such systems can be used to initiate social expression (e.g., sending seasons greetings to a contact during a holiday season using contact information).

However, such systems do not provide a centralized view of the expanded informational items available for a contact because informational items are often spread out amongst a variety of data sources. For example, an informational item about a contact may be stored on a customer relationship management (CRM) data source, a social media/social networking service data source (e.g., Facebook®, LinkedIn®, or Twitter®), or on an external data source (e.g., a news website if the contact has published an article). Further, informational items about a contact may be provided in a data feed (e.g., as may be provided using Real Simple Syndication (RSS) technology).

Awareness of the additional informational items available for a contact makes it easier to communicate social expression in a relevant manner. For example, being aware of a contact's involvement in charitable activities makes it easier to convey social expression relevant to the charitable activities.

Thus, there is a need for improved systems and methods for communicating social expression.

### SUMMARY

The embodiments described herein provide in one aspect, a method for communicating social expression to a contact comprising
a) creating an aggregated social profile, the aggregated social profile comprising a plurality of informational items about the contact collected from a first plurality of data sources;
b) generating at least one keyword from at least one informational item of the plurality of informational items;
c) monitoring a second plurality of data sources for the at least one keyword;
d) raising at least one trigger event if the at least one keyword is identified in the second plurality of data sources; and
e) initiating a social expression action in response to the at least one trigger event.

The embodiments described herein provide in another aspect, a computer-readable storage medium comprising a plurality of instructions for execution on one or more processors, the instructions for performing the steps of the methods described herein.

The embodiments described herein provide in a further aspect, a system for communicating social expression comprising
a) a database for storing at least one aggregated social profile, the aggregated social profile comprising a plurality of informational items about a contact;
b) an aggregation module for collecting the plurality of informational items from a first plurality of data sources; and
c) a monitoring module for monitoring a second plurality of data sources, wherein the monitoring module is configured to
   i) generate at least one keyword from at least one informational item of the plurality of informational items,
   ii) monitor the second plurality of data sources for the at least one keyword,
   iii) raise at least one trigger event if the at least one keyword is identified in the second plurality of data sources, and
   iv) initiate a social expression action in response to the at least one trigger event.

The embodiments described herein provide in a still further aspect, a method for communicating social expression to a contact comprising
a) creating an aggregated social profile, the aggregated social profile comprising a plurality of informational items about the contact collected from a first plurality of data sources;
b) monitoring a second plurality of data sources for a trigger event;
c) initiating a social expression action in response to the at least one trigger event.

In certain embodiments, the trigger event may be inferred. In certain other embodiments, the trigger event may be a predetermined event such a holiday. In certain other embodiments, the trigger event may be the absence of contact by a contact for a certain period of time.

### DRAWINGS

Various embodiments of the present invention will now be described with reference to the drawings, in which:

FIG. 1 is a block diagram of a system for communicating social expression, in accordance with one embodiment of the present disclosure;

FIG. 2 is a flowchart diagram illustrating the steps of communicating social expression, in accordance with one embodiment of the present disclosure;

FIG. 3 is an example schematic diagram of an aggregated social profile;

FIG. 4 is an example illustration of a trigger event;

FIG. 5 is an example illustration of an example list of desired items identified by a contact at a social expression service provider;

FIG. 6 is an example illustration of an example interest hierarchy; and

FIG. 7 is an example flowchart diagram illustrating the steps of communicating social expression, in accordance with another embodiment of the present disclosure;

### DESCRIPTION OF VARIOUS EMBODIMENTS

It will be appreciated that numerous specific details are set forth in order to provide a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered as limiting the scope of the embodiments described herein in any way, but rather as merely describing the implementation of the various embodiments described herein.

The embodiments of the systems and methods described herein may be implemented in hardware or software, or a combination of both. However, preferably, these embodiments are implemented in computer programs executing on programmable computers each comprising at least one processor, a data storage system (including volatile and non-volatile memory and/or storage elements), at least one input device, and at least one output device. For example and without limitation, the programmable computers may be a personal computer, laptop, personal data assistant, cellular telephone, smart-phone device and wireless hypermedia device. Program code is applied to input data to perform the functions described herein and generate output information. The output information is applied to one or more output devices, in known fashion.

Each program is preferably implemented in a high level procedural or object oriented programming and/or scripting language to communicate with a computer system. However, the programs can be implemented in assembly or machine language, if desired. In any case, the language may be a compiled or interpreted language. Each such computer program is preferably stored on a storage media or a device (e.g. ROM or magnetic diskette) readable by a general or special purpose programmable computer, for configuring and operating the computer when the storage media or device is read by the computer to perform the procedures described herein. The subject system may also be considered to be implemented as a computer-readable storage medium, configured with a computer program, where the storage medium so configured causes a computer to operate in a specific and predefined manner to perform the functions described herein.

Furthermore, the system, processes and methods of the described embodiments are capable of being distributed in a computer program product comprising a computer readable medium that bears computer usable instructions for one or more processors. The medium may be provided in various forms, including one or more diskettes, compact disks, tapes, chips, wireline transmissions, satellite transmissions, internet transmission or downloadings, magnetic and electronic storage media, digital and analog signals, and the like. The computer useable instructions may also be in various forms, including compiled and non-compiled code.

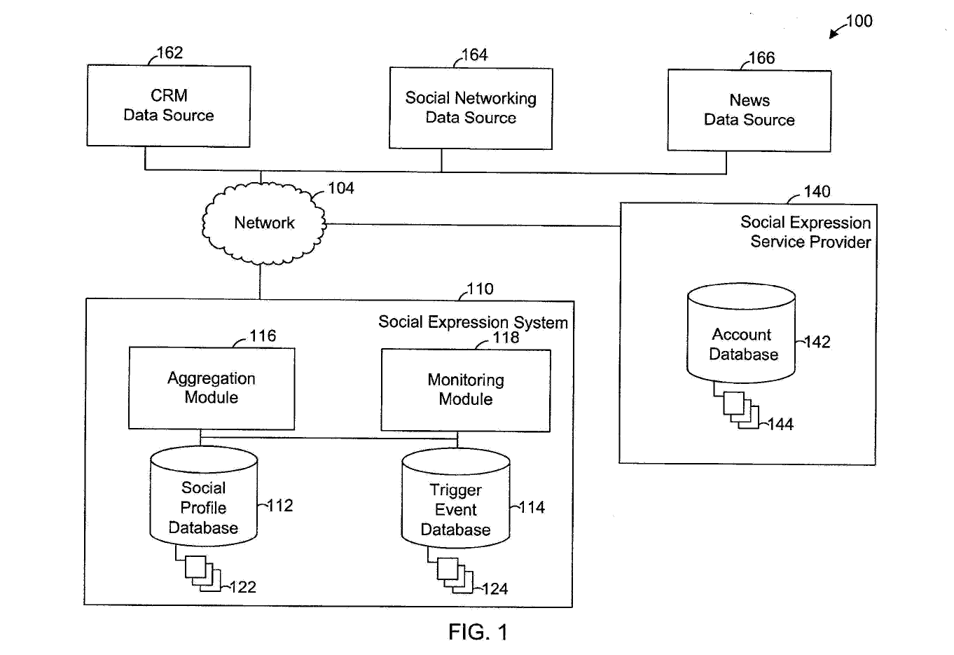

Referring to FIG. 1, illustrated there is a block diagram of a system for communicating social expression in accordance with one embodiment of the present disclosure, referred to generally as 100. The system may include a social expression system 110, a social expression service provider 140, and one or more data sources 162, 164, 166, each operatively connected to a network 104.

Data sources 162, 164, 166 may be any data source accessible over a network 104. For example, they may be a CRM data source 162, a social networking data source 164, or a news data source 166. Each of these data sources may store informational items about various “contacts”, and data from these data sources 162, 164, 166 may be used to generate an aggregated social profile 122.

As used below, it should be understood that the term “contact” is intended to include natural and legal persons. In some cases, for example, a contact who is a legal person (e.g., a corporation), may have several natural person contacts associated with it.

A CRM data source 162 may contain informational items related to managing sales contacts and generating sales leads. Particularly, a CRM data source 162 may store contact information for a contact. As is known in the art, the CRM data source 162 may also store informational items relating to sales campaigns, and the effectiveness of sales campaigns in generating sales with the contact. Examples of a CRM data source may include Salesforce.com® or Microsoft Dynamics® CRM.

A social networking data source 164 may contain informational items about a network of individuals. In addition to appearing in a CRM data source 162, a contact may also be present on a user's social networking data source 164. As is known in the art, some social networking data sources (e.g., Facebook®) may be targeted towards maintaining personal relationships, whereas other social networking data sources (e.g., LinkedIn®) may be targeted towards maintaining business relationships. As such, each type of data source 164 may store different types of informational items related to the contact. For example, a LinkedIn® account may store a contact's career objective and/or work history, whereas a Facebook® account may store a contact's recreational interests. A social networking data source 164 can also be a Twitter® account so that the informational items contain tweets or status updates provided by the contact.

A news data source 166 may contain informational items about a contact that is not necessarily designed for the purposes of maintaining relationships. Such informational items may include information related to a contact appearing in the general or specific media. For example, such news data sources 166 may include mainstream media (e.g., newspapers or broadcasters), blogs or corporate websites.

A communications network 104 may be any type of communications network known in the art suitable for conveying an electronic message. In some embodiments, the communications network 104 may be the Internet. In various embodiments, the communications network may be a local network. It will be understood by one skilled in the art that connections to communications network 104 for the subject embodiment may be made through wired or wireless connections. For example, these may be wireless local area network (WLAN) technologies (e.g., “Wi-Fi”), a physical network connection to a computer network router or switch (e.g., Ethernet), or other cellular/telecommunications technologies (e.g., “WiMax”).

Social expression system 110 may include an aggregation module 116, a monitoring module 118, an aggregated social profile database 112 and a trigger event database 114. Each of these components may be operatively connected to each other through a bus subsystem. In various embodiments, one or more of these components 112, 114, 116, 118 may reside on remote computer systems such that communication amongst them occurs through communications network 104. In such case, it will be understood by those skilled in the art that the various components of social expression system 110 that provides persistent storage (e.g., social profile database 112 and/or trigger event database 114) may be characterized as a remote data storage facility or a data storage facility.

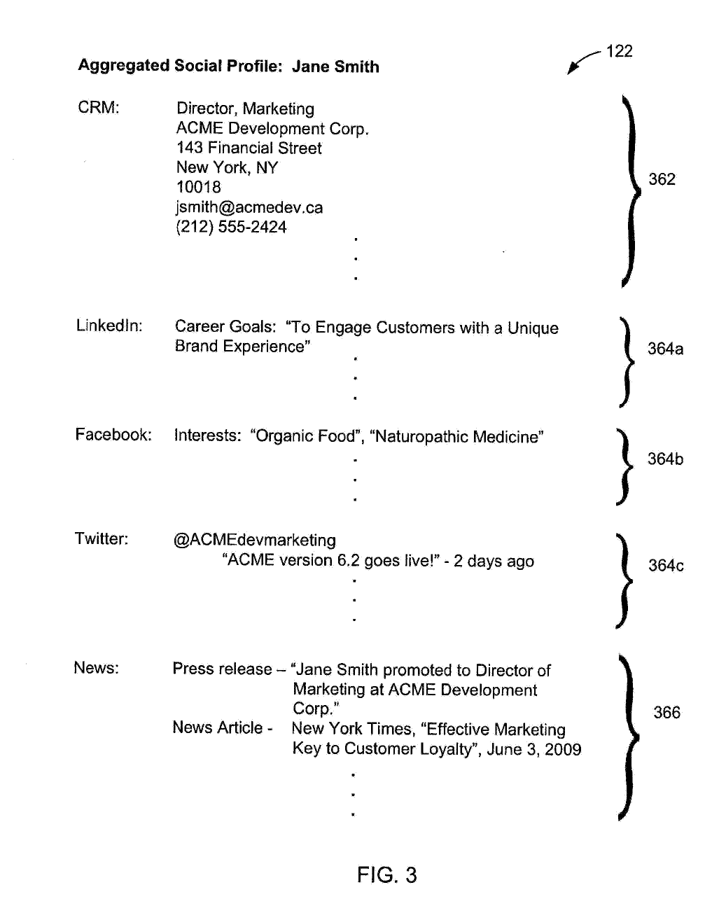

The aggregation module 116 may be configured to create at least one aggregated social profile 122 from a first plurality of data sources 162, 164, 166. That is, since the informational items relating to a contact may be spread out amongst the plurality of data sources 162, 164, 166, the aggregation module 116 may collect the informational items stored on these different data sources 162, 164, 166 to create an aggregated social profile shown generally as 122. Referring briefly to FIG. 3, shown there is an example aggregated social profile 122, in which informational items from a CRM data source 362, three social networking data sources 364a, 364b, 364c and 364d, and a news data source 366 have been aggregated together.

As is known in the art, such informational items may be accessible from data sources 162, 164, 166 via Application Programming Interfaces (APIs) made available by the data sources 162, 164, 166. Additionally or alternatively, the informational items may be gathered through web spiders or crawlers that are operable to scan webpages provided by data sources 162, 164, 166 for informational items relating to a contact. In various embodiments, the informational items may be retrieved through technologies designed to provide a news or data feed (e.g., Real Simple Syndication (RSS)). The aggregation module 116 may also be operable to continually operate so as to be able to retrieve and/or receive up-to-date informational items about a contact and add it to the aggregated social profile 122 for a contact.

Social profile database 112 may be configured to store at least one aggregated social profile 122, the aggregated social profile comprising informational items about a contact. As noted, the informational items may be information stored on one or more data sources 162, 164, 166, and may contain contact information for initiating communication with the contact (e.g., an email address stored in a CRM data source 162), or information about the contact's personal or professional life (e.g., if it is a social networking data source 164). Once formed, the aggregated social profile 122 of a contact may provide context for the monitoring of trigger events 124 relevant to the contact.

Monitoring module 118 may be configured to monitor a second plurality of data sources for at least one trigger event related to at least one informational item about a given contact in the aggregated social profile 122. In the example embodiment, the first and second plurality of data sources are illustrated as the same plurality of data sources 162, 164, 166. However, it will be understood that in other embodiments, the second plurality of data sources may include some or none of the first plurality of data sources 162, 164, 166. The monitoring may be performed using the same mechanisms (discussed above) used to aggregate informational items from the data sources 162, 164, 166.

In various embodiments, the monitoring module 118 may be configured to generate at least one keyword from at least one informational item of the plurality of informational items in the aggregated social profile 122. The monitoring module 118 may then be configured to scan for the at least one keyword in the second plurality of data sources 162, 164, 166 so that a trigger event 124 is raised if there is a keyword match in the second plurality of data sources 162, 164, 166. For clarity, as used herein, the term “trigger event” may include the message being raised by the monitoring module 118, as well as the informational item occurring in the second plurality of data sources that has been identified as relevant to the aggregated social profile 122.

For example, referring briefly again to FIG. 3, shown there is an aggregated social profile 122 for a contact ‘Jane Smith’. The monitoring module 118 may be configured to examine the Facebook® social network informational items 364b, and generate keywords relating to the contact's interest in “organic food” (e.g., generating a keyword “organic”). Such keyword(s) may then be used by monitoring module 118 to scan the second plurality of data sources 162, 164, 166. If there is a match, a trigger event 124 may be raised. An example of such a trigger event 124 may include the publishing of a news article related to the health benefits of consuming organic food.

In another embodiment, the monitoring module 118 may be configured to monitor (such as on a daily basis or more or less frequently) social networking ‘chatter’ and/or new feeds for one or more contacts in the aggregated social profile 122 for trends in order to generate one or more keywords relating to a contact's interest. Networking ‘chatter’ may include messages posted by a contact. For example, if the monitoring module 118 identifies that the contact is engaging in on-line social conversations and/or posts messages, that contain the keyword “hockey”, the monitoring module 118 can add the keywords “hockey” and also “sports” to the contact's social profile 122. Referring to FIG. 6, a predefined keyword interest hierarchy may used to identify such keywords and to also associate keywords to other keywords. In the previous example, the keyword “hockey” is associated with “sports” because it is a subset of sports in the interest hierarchy. Such keywords may then be used by monitoring module 118 to scan the second plurality of data sources 162, 164, 166. If there is a match, a trigger event 124 may be raised. An example of such a trigger event 124 may include the publishing of a news article related to a hockey show.

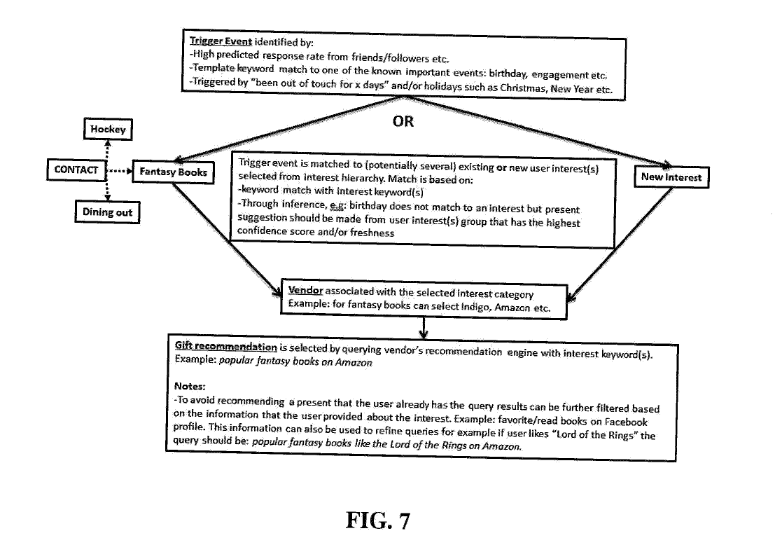

Referring to FIG. 7, in another embodiment, the monitoring module 118 may be configured to generate a confidence score using a weighted average of the number (counts) of related actions performed by a contact. The confidence score may be reflective of a contact's level of interest (interest strength) in a certain topic, subject and the like. Related actions (actions which related to a contact's interest(s) may include one or more of the following actions by a contact:
clicking “like” on a message/topic/picture etc. related to the contact's interest;
posting a message related to the contact's interest (this includes picture comments); and,
listing a profile under interests or in other fields on a networking site such as Facebook®.

Related actions may also include a count of the number of friends/followers and the like who share a particular interest(s) in common with a contact.

The confidence score may be updated with every related action. Friends' interest confidence may be weighted based on their importance to the contact which include: relationship, frequency of interaction, length of friendship etc. which may be indicated in an aggregated contact profile.

Confidence Score Example

A confidence score associated with an interest ‘hockey’, the inputs may be:

Hockey does not appear on the contact's interests page: x₁=0

User posted ‘hockey’ related messages 70 times during the last year out of the total of 400 posts for that year: x₂=70/400

Contact clicked ‘like’ on hockey related posts and pictures 30 times during the last year out of the total of 150 likes for that year: x₃=30/150

Contact's closest friends have an average confidence score of 0.7 for hockey: x₄=0.7

Contact's other friends have an average confidence score of 0.4 for hockey: x₅=0.4

CONFIDENCE(hockey)=0.3x₁+0.2x₂+0.1x₃+0.3x₄+0.1x₅=0.305

A contact's interest(s) may change with time and the freshness of the interest reflects how recent a particular interest is. The monitoring module 118 may be configured to generate either or both of the following which may be reflective of freshness of a contact's interest(s):
number of related actions by a contact in the last week/month/year etc. relative to all actions during those periods; and
elapsed time since the most recent related action by a contact.

A trigger event 124 may be raised by a keyword match by the monitoring module 118 with a template of predefined keywords representing important life event such as graduation, engagement, marriage, job promotion, birth of a child or death of a loved one.

In another embodiment, the monitoring module 118 may be configured to automatically raise a trigger event 124 when an event occurs such as Christmas, New Years etc. or when a contact has not been in touch (such as by not logging in to a social networking site) for a certain period of time (for example, 1 week).

In another embodiment, a trigger event may be matched to (potentially several) existing or new contact's interest(s) through an inference, e.g: birthday does not match to an interest but present suggestion should be made from a contact's interest(s) group that has the highest confidence score and/or freshness.

The user may decide to use a retailer or vendor such as Amazon.com® for providing the social expression action in response to a trigger event 124. In such case, the social expression system 110 may be configured to interface with a retailer or vendor associated with a selected interest category. In another embodiment, the monitoring module 118 may be configured to automatically interface with a retailer or vendor upon a trigger event to provide a social expression action.

A gift recommendation(s) may be made by querying a recommendation engine of one or more retailers or vendors with interest keyword(s)—for example: popular fantasy books on Amazon

In an embodiment, in order to avoid recommending a gift that the contact already has, the query results may be further filtered based on the information that the contact provided about the interest—for example: favorite/read books on a contact's Facebook profile. This information can also be used to refine queries for example if a contact likes “Lord of the Rings” the query could be: popular fantasy books like the Lord of the Rings on Amazon.com

Once at least one trigger event 124 has been identified in the second plurality of data sources 162, 164, 166, monitoring module 118 may also be configured to initiate a social expression action in response to the at least one trigger event 124. The monitoring module 118 may be configured to analyze a trigger event 124 or other informational items in the aggregated social profile 122 to determine the appropriate social expression action. For example, the monitoring module 118 may determine the data source 162, 164, 166, from which the trigger event 124 originated, and cater the social expression action to the trigger event 124 accordingly.

In a news data source 166, a trigger event 124 may be the publishing of an article relevant to the contact. For example, the initiation of a social expression action may involve the monitoring module 118 forwarding the at least one trigger event 124 to the contact that the trigger event 124 was pertinent to. In the example discussed, this may involve forwarding a copy of the news article discussing the health benefits of organic food to ‘Jane Smith’.

In a CRM data source 162, a trigger event 124 may be the completion of a sale. In such case, the social expression action may include sending a note that thanks the contact for their business.

In a social networking data source 164, a trigger event 124 may be the updating of a profile, or tweets/status updates (whether it be that of the contact associated with the aggregated social profile 122 or that of another contact). For example, if the trigger event 124 pertains to the contact of the aggregated social profile 122, and a status update indicates that the contact is taking a vacation to Brazil, the social expression action may include sending the contact a link to a website on Brazilian tourism.

If the trigger event 124 is associated with a second contact, i.e., not the contact of the aggregated social profile 122, the social expression action may include transmitting contact information of either the second contact or the contact of the aggregated social profile 122. For example, if the second contact provides a status update to indicate that they are looking for a real estate agent, this may generate a trigger event 124 for a contact whose profession is a real estate agent (as would be indicated in their aggregated social profile 122). This may result in a social expression action that sends the contact information for the contact of the aggregated social profile 122 to the second contact.

In another example, a contact may have published a status update indicating that they were looking for an investment advisor such that this informational item shows up in their aggregated social profile 122. The monitoring module 118 may then be operable to monitor for trigger events 124 relevant to this informational item such that if a second contact updates their profile in a social networking data source 164 to indicate a change in career to become an investment advisor, this may result in a trigger event 124 being generated for the first contact. In response to such trigger event 124, the monitoring module 118 may be configured to initiate a social expression action that transmits the contact information of the second contact to the first contact.

In some embodiments, the monitoring module 118 may be able to operate in conjunction with the aggregation module 116 to add the informational item that caused the trigger event 124 to an aggregated social profile 122 for a corresponding contact.

Trigger event database 114 may store the trigger events 124 that the monitoring module 118 has flagged for a user's attention. It may also store the type and content of any social expression actions that were initiated as a result of a trigger event 124.

Monitoring module 118 may reference the trigger event database 114 for trends before initiating a social expression action. For example, if a contact typically has many trigger events 124 being generated around a certain timeframe of the year (e.g., if a software company has a yearly release scheduled for several products around September of every year), monitoring module 118 may be operable to identify such trend so as to only initiate one social expression action in response to multiple trigger events 124.

In some embodiments, initiating the social expression action may involve the monitoring module 118 placing an order with a social expression service provider 140. A social expression service provider may be, for example, a greeting card provider, a bookstore, a florist. The social expression service provider 140 may be operatively connected to network 104 so as to allow communication to and from social expression system 110. The placing of an order may involve the sending of a greeting card or book associated with the trigger event 124 which caused the initiation of the social expression action. For example, this may involve the placement of an order for sending a congratulatory card if a trigger event 124 is the announcement of a promotion through a press release in news data source 166.

Social expression service provider 140 may include an account database 142 that stores service provider accounts 144 for providing the social expression service. In some embodiments, the contact associated with the aggregated social profile 122 may hold a service provider account with the social expression service provider 140 such that the monitoring module 118 may further be configured to communicate a service provider account identifier for the account to the social expression service provider 140 when placing an order. For example, the account identifier may be the email address of the contact of the aggregated social profile 122.

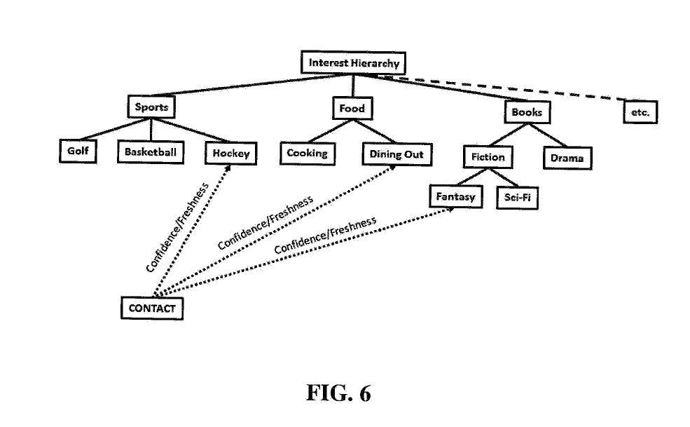

Using this account identifier, the social expression service provider 140 may be able to fulfill the order placed by the monitoring module 118 by using information available on the service provider account 144. For example, such information may include a list of desired items identified by the contact (i.e., a wishlist), and the order may be able to select at least one of these items on the list to fulfill the order. It will be understood that the desired items may not necessarily be items desired by the contact themselves; i.e., the desired items may be desired for acquaintances of the contact. Referring briefly to FIG. 5, illustrated there is an example wish list for an example bookstore social expression service provider.

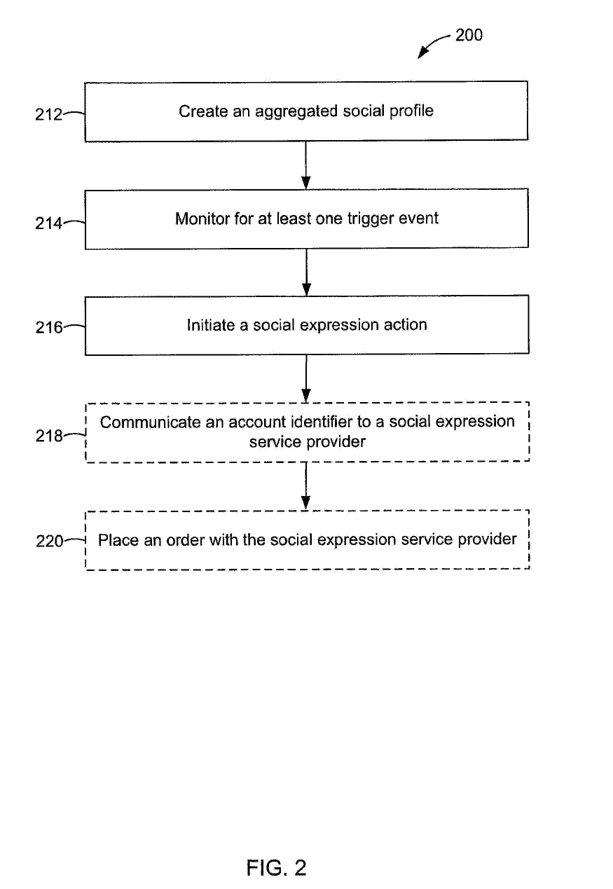

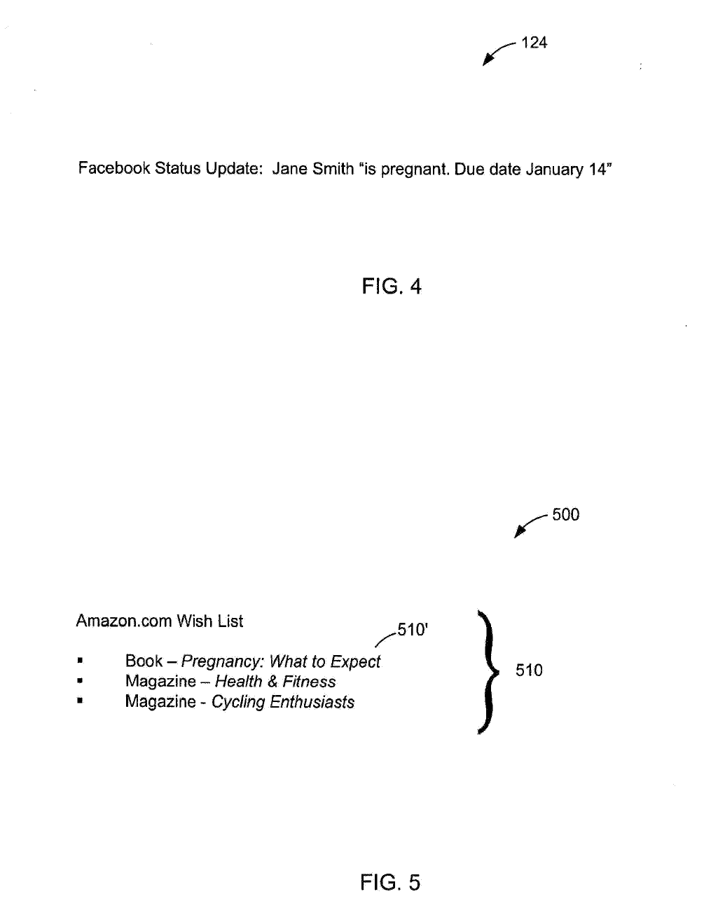

Referring to FIG. 2, shown there is a flowchart diagram illustrating the steps of a method for communicating social expression, shown generally as 200. To better illustrate the steps of the method, simultaneous reference will also be made to the exemplary aggregated social profile 122 in FIG. 3, the example trigger event 124 in FIG. 4, and the components described above in FIG. 1.

At step 212, the aggregation module 116 may create an aggregated social profile from a first plurality of data sources 162, 164, 166. Such aggregated social profile 124 may include informational items for a plurality of characteristics of a contact.

Referring to FIG. 3, shown there is an example aggregated social profile 122 for a contact ‘Jane Smith’. As illustrated, informational items about her from a variety of data sources 162, 164, 166 has been collected together into the aggregated social profile 122. There are CRM informational items 362 that include contact information for Jane Smith (e.g., her mailing address, phone number and email address), as well as Jane Smith's position (Director of Marketing) and employer (ACME Development Corp.).

These informational items may be supplemented by social network information 364a, 364b, 364c from social networking data sources 164. In the example, Jane Smith's aggregated social profile 122 includes social network informational items 364a from the LinkedIn® social network typically used for business relationships, and social network informational items 364b from the Facebook® social network typically used for personal relationships. As illustrated, it can be seen that Jane Smith's LinkedIn® social network informational item 364a indicating that her career goal is “To Engage Customers with a Unique Brand Experience” has been captured in the aggregated social profile 122. Also, it can be seen that Jane Smith's Facebook® social network informational item indicating her personal interests in “organic food” and “naturopathic medicine” has also been captured in the aggregated social profile 122. Further, it can be seen that Jane Smith's Twitter® social network informational items 364c (including tweets from her Twitter® account such as that announcing the release of AMCE version 6.2) has also been captured.

Additionally, it can be seen that news informational items 366 from a news data source 166 for Jane Smith has also been collected into aggregated social profile 122.

In the example, news informational items about Jane Smith include a press release from ACME Development Corp. announcing her promotion to her current Director of Marketing position, and an article by Jane Smith published on Jun. 3, 2009 in the New York Times newspaper entitled “Effective Marketing Key to Customer Loyalty”.

All the informational items 362, 364a, 364b, 364c, 366 about the contact Jane Smith stored in the aggregated social profile 122 may be stored in the social profile database 112.

At step 214, the monitoring module 118 monitors a second plurality of data sources 162, 164, 166 for at least one trigger event 124 related to the informational items about the contact.

As noted above, in some embodiments, the informational items in the aggregated social profile 122 may be analyzed by monitoring module 118 to generate keywords for identification in the second plurality of data sources 162, 164, 166. In some cases, the keywords may simply be the contact's name or the text in the informational items in the aggregated social profile 122. If a keyword is identified in the second plurality of data sources 162, 164, 166, the monitoring module 118 may raise a trigger event 124. As noted, the term “trigger event” may include the message being raised by the monitoring module 118, as well as the informational item occurring in the second plurality of data sources that has been identified as relevant to at least one informational item in the aggregated social profile 122.

Referring to FIG. 4, shown there is an example illustration of a trigger event, shown generally as 124. In the example, the trigger event 124 can be a status update posted by Jane Smith on the Facebook® social networking data source 164. As illustrated, Jane Smith updates her Facebook® status update to “is pregnant. Due date January 14^{th}.”

At step 216, the monitoring module 118 may initiate a social expression action in response to the at least one trigger event 124. When deciding on the nature of the social expression action, monitoring module 118 may be able to analyze the trigger event 124 to determine the type of action that is appropriate. In the example, the trigger event 124 contains an informational item indicating that Jane Smith is pregnant. As such, the social expression action can be related to the topic of pregnancy. For example, the social expression action may include sending a congratulatory note in an email to Jane Smith, or sending the contact information for a second contact who is a gynecologist to Jane Smith.

The monitoring module 118 may also determine a social expression action (such as a relevant gift) based on one or more of the following: a contact's social profile; keywords; on-line social conversations and/or message post by a contact; relationship category and relationship strength.

The analysis of the trigger event 124 by monitoring module 118 may also cause monitoring module 118 to schedule a social expression action to be initiated in the future. In this example, the monitoring module 118 may be operable to initiate the sending of a congratulatory gift basket closer to the January 14^{th} due date of the baby that Jane Smith is expecting.

When analyzing the trigger event 124, monitoring module 118 may further be operable to use multiple informational items in the aggregated social profile 122 to determine the meaning of the information in the trigger event 124. For example, if Jane

Smith's Facebook® status update was more obscure in announcing her pregnancy (e.g., if the status update was “is expecting”, or “new addition arriving soon”), monitoring module 118 may be operable to cross-reference the social network informational items 364a in her LinkedIn® account to determine that she has indicated there that she will be on maternity leave soon. Viewed another way, the updating of the social network informational items 364a in Jane Smith's LinkedIn® account can also be considered a trigger event 124.

As indicated above, the monitoring module 118 may be configured to analyze the trigger events 124 being generated and stored in trigger event database 114 for trends. One such trend may be that trigger events 124 may tend to be generated in multiple data sources 162, 164, 166 at roughly around the same time (e.g., if the same message is posted in a Facebook® status update and a Twitter® tweet). After identifying such trend, monitoring module 118 may be operable to delay the initiating of a social expression action in response to a trigger event 124. That is, it may wait to see if other related trigger events 124 will be generated (in other or the same data source 162, 164, 166). Such delay may help to avoid overwhelming a contact with social expression actions, and streamline the options presented to the user of social expression system 110 for responding to a trigger event 124. It may also allow verification of the meaning of a trigger event 124 by means of referring to another trigger event 124 (as discussed above).

At step 218 (indicated in dotted outline), the monitoring module 118 may optionally communicate an account identifier to a social expression service provider 140. As discussed above, the social expression service provider 140 may have an account database 142 storing accounts 144 used by the social expression service provider 140 to providing its social expression service. In one embodiment, the account identifier may be the email address of the contact associated with the aggregated social profile 122, as may be retrieved from CRM informational items 362.

In the example, the user may decide to use an online retailer such as Amazon.com® for providing the social expression action. In such case, the social expression system 110 may be configured to send Jane Smith's email address (“jsmith@acmedev.ca”) in her aggregated social profile 122 to Amazon.com® as an account identifier. The Amazon.com® social expression service provider may then use data in Jane Smith's account 144 in providing the social expression action. As noted, the account information may be a list of desired items (e.g., a wishlist) identified by Jane Smith.

Referring simultaneously to FIG. 5, there is an example illustration of a list of items identified by a contact at a social expression service provider 140. The list of items 510 shown there is an example wishlist at Amazon.com® that Jane Smith has created. It can be seen that Jane Smith has indicated three items that she would like: a book 510′ entitled Pregnancy: What to Expect, and two magazines entitled Health & Fitness and Cycling Enthusiasts respectively.

As discussed above, the monitoring module 118 may be configured to analyze the trigger event 124 to determine the appropriate social expression action. In the example, the monitoring module 118 may be able to determine that the trigger event 124 announced Jane Smith's pregnancy, and the book 510′ entitled Pregnancy: What to Expect illustrated in FIG. 4 can be provided to the user of social expression system 110 as a choice for sending as a gift to Jane Smith as the responding social expression action.

Additionally or alternatively, the monitoring module 118 may be configured to analyze the plurality of informational items in the aggregated social profile 122 to determine the appropriate social expression action. That is, the monitoring module 118 may use contextual informational items available in the aggregated social profile 122 for a contact to identify additional choices for the social expression action. In the example, the monitoring module 118 may be able to examine Jane Smith's aggregated social profile 122, and determine from her Facebook® social network informational items 364b that she has an interest in organic food and naturopathic medicine (as shown in FIG. 3). As such, monitoring module 118 may search for an item at the social expression service provider 140 that is relevant to these identified interests and the informational item of the trigger event 124. In such case, monitoring module 118 may identify a book (not shown) entitled Organic Foods for a Healthy Pregnancy at the Amazon.com® social expression service provider 140 that encompasses Jane Smith's interest in organic foods and her announcement that she is pregnant.

In various embodiments, monitoring module 118 may further include other search criteria for identifying options for the social expression action. For example, this may include the keyword used by the monitoring module 118 when scanning for trigger events 124, the geographic location of either the user of social expression system 110 or the contact associated with the aggregated social profile 122, or a price range for the social expression action.

Once the option(s) for the social expression action has been identified by the monitoring module 118, the options may be presented to the user of a social expression system. The user may then select the appropriate social expression action in responding to the trigger event 124. In the example, the user may be presented with two book choices for sending to Jane Smith in view of the trigger event 124 announcing her pregnancy: a book entitled Pregnancy: What to Expect and a book entitled Organic Foods for a Healthy Pregnancy. Since the latter book is more contextually relevant to Jane Smith given her interest in organic food as determined through reference to her aggregated social profile 122, the user of the social expression system 110 may select the latter option.

In various embodiments, the monitoring module 118 may be configured to automatically complete the social expression action without presenting choices to the user of social expression system 110. In such case, the monitoring module 118 may use criteria available from the social expression service provider 140 to make a default choice. For example, the monitoring module 118 may select the best selling item of the choices that would have otherwise been presented to the user as the default choice.

After selecting the option, the monitoring module 118 may be configured to provide an option to personalize the item being sent for social expression action. In the example, this may include a congratulatory note to Jane Smith saying,

“Congratulations on the new addition to the family, Jane! Hope this book helps you stay healthy during the pregnancy!”

In various embodiments, a standard prepared message related to the trigger event 124, the contact, and/or the informational items in the aggregated social profile 122 may be provided by the monitoring module 118.

At step 220, the monitoring module 118 may optionally place an order with the social expression service provider 140. This step may be applicable (the step being illustrated in dotted outline) if the social expression action involves a social expression service provider. That is, once the user of social expression system 110 chooses an item to be sent for the social expression action, the order can be placed at the social expression service provider 140. In the example, an order can be placed for the book entitled Organic Foods for a Healthy Pregnancy at the Amazon.com® social expression service provider 140 and sent to Jane Smith. As noted above, the monitoring module 118 may be operable to provide the mailing address stored in the aggregated social profile 122 (e.g., as may be retrieved from CRM informational items 362 illustration in FIG. 3). Alternatively, a user of social expression system 110 may choose to use the mailing address stored on the account 144 for the contact Jane Smith at the social expression service provider 140. If the addresses are different (i.e., one is a work address, and the other is a home address), the user of social expression system 110 may be presented with the option of choosing which address is appropriate depending on the nature of the relationship of the user with the contact.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the invention and non-limiting and it will be understood by persons skilled in the art that other variants and modifications may be made without departing from the scope of the invention as defined in the claims appended hereto.

1. A method for communicating social expression to a contact, the method comprising
a) creating an aggregated social profile, the aggregated social profile comprising a plurality of informational items about the contact collected from a first plurality of data sources;
b) generating at least one keyword from at least one informational item of the plurality of informational items;
c) monitoring a second plurality of data sources for the at least one keyword;
d) raising at least one trigger event if the at least one keyword is identified in the second plurality of data sources; and
e) initiating a social expression action in response to the at least one trigger event.

2. The method of claim 1, wherein said the second plurality of sources comprises a data feed.

3. The method of claim 1, further comprising
a) analyzing the at least one trigger event to determine the appropriate social expression action.

4. The method of claim 1, further comprising
a) analyzing the plurality of informational items to determine the appropriate social expression action.

5. The method of claim 1, wherein the social expression action comprises
a) placing an order with a social expression service provider.

6. The method of claim 5, wherein the social expression service provider is selected from the group consisting of: a greeting card provider, a bookstore and a florist.

7. The method of claim 5, wherein a user holds an account with the social expression service provider, and said placing an order comprises
a) communicating an account identifier for the account to the social expression service provider.

8. The method of claim 7, wherein the account comprises a list of desired items identified by the user, and the order comprises at least one desired item on the list.

9. The method of claim 1, wherein the social expression action comprises
a) forwarding the at least one trigger event to the user.

10. The method of claim 1, wherein the first and second plurality of data sources are the same plurality of data sources.

11. The method of claim 1 further comprising the step of generating a second keyword which is related to the first keyword.

12. A computer-readable storage medium comprising a plurality of instructions for execution on one or more processors, the instructions for performing the steps of the method of claims 1.

13. A system for communicating social expression comprising
a) a database for storing at least one aggregated social profile, the aggregated social profile comprising a plurality of informational items about a contact;
b) an aggregation module for collecting the plurality of informational items from a first plurality of data sources; and
c) a monitoring module for monitoring a second plurality of data sources, wherein the monitoring module is configured to
i) generate at least one keyword from at least one informational item of the plurality of informational items,
ii) monitor the second plurality of data sources for the at least one keyword,
iii) raise at least one trigger event if the at least one keyword is identified in the second plurality of data sources, and
iv) initiate a social expression action in response to the at least one trigger event.

14. The system of claim 13, wherein the second plurality of data sources comprises a data feed.

15. The method of claim 13, wherein the monitoring module is further configured to
a) analyze the at least one trigger event to determine the appropriate social expression action.

16. The method of claim 15, wherein the monitoring module is further configured to
a) analyze the plurality of informational items to determine the appropriate social expression action.

17. The system of claim 13, wherein when initiating the social expression action, the monitoring module is further configured to place an order with a social expression service provider.

18. The system of claim 15, wherein the social expression service provider is selected from the group consisting of: a greeting card provider, a bookstore and a florist.

19. The system of claim 15, wherein the contact holds an account with the social expression service provider, and the monitoring module is further configured to communicate an account identifier for the account to the social expression service provider.

20. The system of claim 13, wherein when initiating the social expression action, the monitoring module is further configured to forward the at least one trigger event to a user.

21. The system of claim 13, wherein the trigger event is associated with a second contact, and when initiating the social expression action, the monitoring module is further configured to transmit contact information for the second contact to a user.
